(19) United States
(12) Patent Application Publication
(10) Pub. No.: US 2022/0356751 A1
(43) Pub. Date: Nov. 10, 2022

(54) Security Screen Assembly

(71) Applicant: Qulok IP Pty Ltd, Cleveland (AU)

(72) Inventor: Beau Blakemore, Cleveland (AU)

(21) Appl. No.: 17/556,162

(22) Filed: Dec. 20, 2021

(30) Foreign Application Priority Data
May 10, 2021 (AU) 2021901384

(51) Int. Cl. E06B 5/11; E06B 3/72; E06B 3/76; E06B 3/16

(52) U.S. Cl. CPC E06B 5/113; E06B 3/728; E06B 3/76; E06B 3/16; E06B 2003/7049

(57) ABSTRACT

A security screen assembly for a door or window is disclosed herein. The assembly includes a frame with a reinforced lip, a mesh, a plastic insulator to insulate the frame from the mesh and a retaining wedge to hold the mesh in the frame. The characterising feature is that the mesh has cut and punched indentations which abut against the reinforced lip within the plastic insulator to prevent the mesh being withdrawn from the frame once the retaining wedge is in place.

### BACKGROUND OF THE INVENTION

### 1. Field of the Invention

The present invention relates to the door manufacturing industry and, more particularly to a method of attaching a screen mesh to a security door frame or window frame to securely hold it in place.

### 2. Description of the Related Art

Referring to FIG. 1, a mesh door assembly 10 comprises a mesh 12 and a frame 14. There are various means in the prior art for attaching the mesh 12 to the frame 14.

For example, a prior art mesh door assembly 16 made by Crimsafe Security Systems Pty Ltd is shown in FIG. 2. This door assembly 16 comprises a stainless steel mesh 18 fixed to an aluminium frame 20. The mesh 18 is held in place with screws 22. These screws 22 create connection between dissimilar metals. The dissimilar metals react and cause corrosion. For this reason, plastic sheaths 24 are used to avoid direct contact between the aluminium frame 20 and the stainless steel mesh 18. However, the steel screws 22 still come into direct contact with the aluminium frame 20 which causes corrosion. The screws 22 and the area around them in the frame 20 eventually become corroded, rusty and weak. The purpose of the screws 22 is to firmly secure the mesh 18 and prevent unauthorised forced entry through the door. However, the corroded components degrade the strength of the door 16.

FIG. 3 shows another example of a mesh door assembly 26 produced by ABRA Aluminium Pty Ltd trading as Panther Protect™. This assembly 26 has an aluminium frame 28 and a stainless steel mesh 30 which are isolated from each other using a plastic liner 32. The stainless steel mesh 30 is curved around a load leg 34 within the plastic liner 32 in order to retain the stainless steel mesh 30 within the aluminium frame 28. The plastic liner 32 has a retaining wedge 36 which retains the mesh 30 in the frame 28. This design of security screen avoids the problem of corrosion. However, it has a design flaw in that the top edge of the mesh 30 is not secured with a folded edge. This creates a weak point in the security screen 26 which makes it more vulnerable to a forced entry by an intruder. During assembly of the security screen 26, the frame 28 has to be slid on the mesh 30 from the side. The mesh 30 is retained in the bottom load leg 34. However, there is no mesh 30 behind a top load leg (not shown) on the top of the frame 26 to create tension at the top of the mesh 30.

A prior art South Korean patent application number KR20110015214A discloses a prior art mesh door assembly 27 comprising a frame 29 with a step 31, a mesh 33 with a folded edge 35 and a retaining wedge 37 to hold the mesh 33 in the frame 29. The assembly 27 relies on a screw 39 to hold the mesh 33 within the frame 29. However, corrosion can occur between the screw 39, the frame 29 and the mesh 33. Another inherent problem with this prior art assembly 27 is that it is time-consuming to construct because of the extensive amount of screws required. An average door assembly 27 would have about thirty to forty screws in it, which are time consuming to install. The exposed screw heads 39 are also unsightly in the door assembly 27.

There are many other designs of security screens which use only a retaining wedge to hold the mesh in the frame under friction. However, security screens which rely solely on a retaining wedge (for example, in the absence of screws) are relatively weak and vulnerable to intruders.

The object of the present invention is to provide a mesh door which is both highly resistant to attack from intruders and resistant to corrosion. Another object of the present invention is to provide a mesh door which does not rely on screws to retain the mesh in the door.

### SUMMARY OF THE INVENTION

According to a first aspect of the present invention, there is provided a security screen assembly comprising:
(a) a frame with a reinforced lip;
(b) a mesh;
(c) a plastic insulator to insulate the frame from the mesh; and
(d) a retaining wedge to hold the mesh in the frame;
wherein the mesh has cut and punched indentations which abut against the reinforced lip and the plastic insulator to prevent the mesh being withdrawn from the frame once the retaining wedge is in place.

According to a second aspect of the present invention, there is provided a method of assembling a security screen, the method comprising:
(a) cutting and punching indentations along the perimeter of a mesh;
(b) forming a frame with a reinforced lip;
(c) inserting the mesh into each side of a frame so that the indentations abut the reinforced lip; and
(d) inserting wedges between the frame and the mesh to retain the mesh in the frame.

Preferably, the security screen is part of a door, and the door has a strip along its edge adjacent to a door jamb to prevent the insertion of a tool between the door and the door jamb to prise the door open. The strip may be formed in different sizes to allow for adjustment to suit uneven gaps between the door and a pre-existing door jamb.

Any of the features described herein can be combined in any combination with any one or more of the other features described herein within the scope of the invention.

### BRIEF DESCRIPTION OF THE DRAWINGS

Embodiments of the invention will be described with reference to the following drawings, in which:

FIG. 1 is mesh screen door assembly showing the product to which the present invention relates.

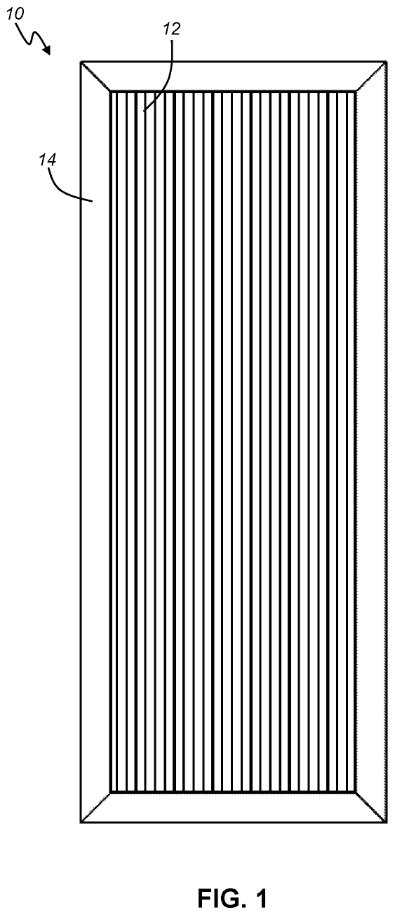

FIG. 2 is a perspective view of a section of a prior art mesh door assembly made by Crimsafe Security Systems Pty Ltd.

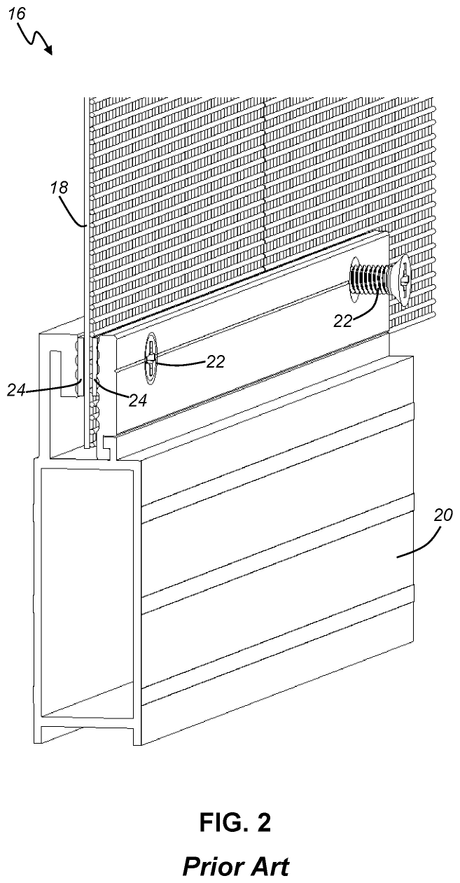

FIG. 3 is a perspective view of a section of a prior art mesh door assembly made by ABRA Aluminium Pty Ltd trading as Panther Protect™.

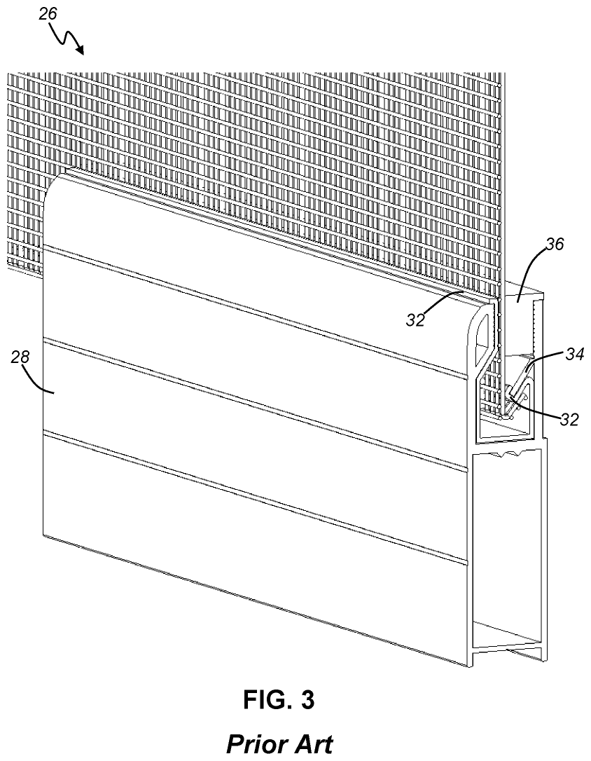

FIG. 4 is a side section view of a prior art mesh door assembly of KR20110015214A.

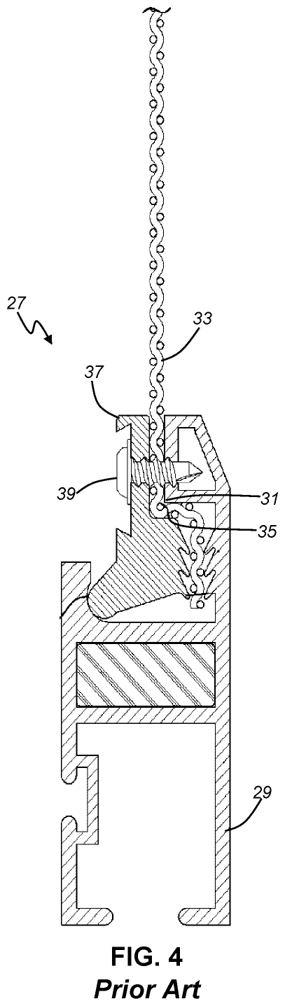

FIG. 5 is a perspective view with close up views of the mesh of a security door screen according to an embodiment of the present invention.

FIG. 6 is a side section view of the security door screen assembly according to the present invention.

FIG. 7 is a close up view of the retaining wedge of the security door screen assembly of FIG. 5.

FIG. 8 is a side view up view of the door frame of the security screen assembly of FIG. 5.

FIG. 9 is a side view up view of a window frame of the security screen assembly of FIG. 5.

### DETAILED DESCRIPTION OF THE INVENTION

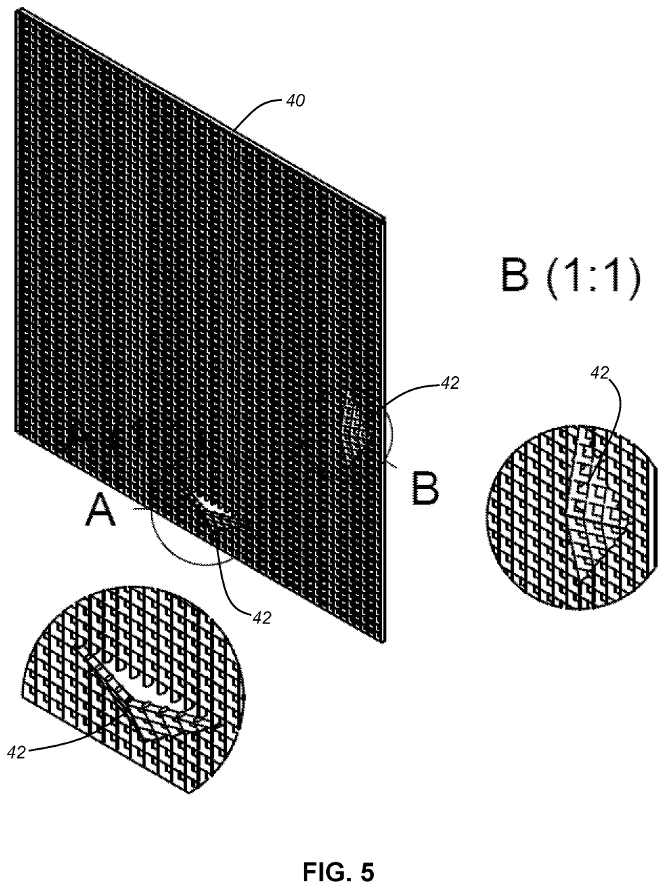

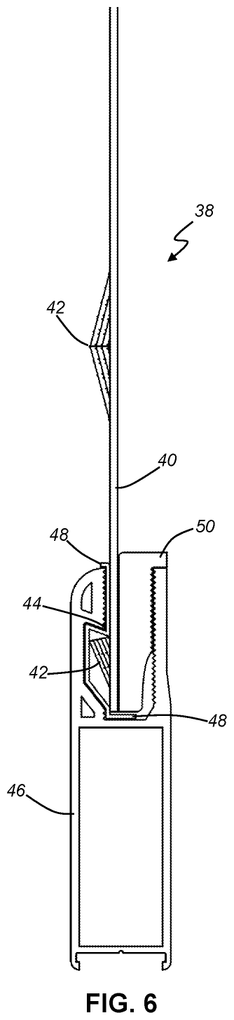

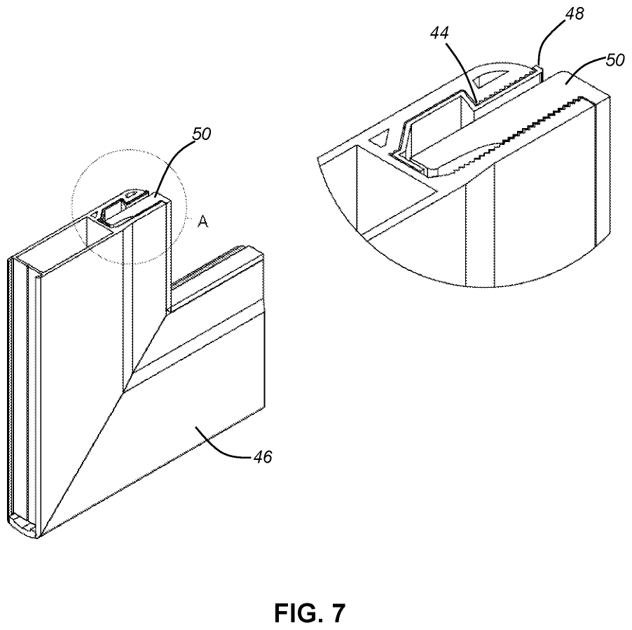

The components of a security screen assembly 38 according to an embodiment of the present invention are shown in FIGS. 5 to 9. A stainless steel mesh 40 has indentations 42 which are cut and punched at regular intervals along the perimeter of the mesh 40. The indentations 42 are anchored against a reinforced lip 44 of an aluminium frame 46 (see FIG. 6). A plastic insulator 48 is positioned between the stainless-steel mesh 40 and the aluminium frame 46 so that the dissimilar metals do not come in contact. The cut and punched indentations 42 are regularly spaced along all sides of the mesh 44 so that all edges of the mesh 40 can be effectively anchored to the frame 46.

The indentations 42 are press formed (i.e. cut and punched) with either a manual machine or a large hydraulic machine capable of automatically pressing all indentations for one side in a single action. This method of constructing the security screen 38 is significantly more efficient than the prior art method of putting screws at each anchor point.

An intruder may attempt to force entry through the door by pushing on the mesh. However, as more force is applied on the mesh, the distortion of the indentations increases which locks the mesh more tightly to the frame. By contrast, previous mesh door assemblies such as use a mesh with a folded edge which can be more easily pulled from the frame. When the folded edge is placed under load it flattens back out to its original shape. However, this cannot occur with the cut and punched indentations of the present invention. The indentations cannot return to their original shape when the mesh is placed under load.

In the prior art, the screws are generally spaced every 150 mm along each edge of the frame. An average door would have thirty to forty screws in it, which are time consuming to install. As the number of indentations do not affect manufacturing time of the present invention, the size to indent ratio can be adjusted to maximise the strength of the security screen. For example, a good strength to indent ratio is provided by having each cut approximately 40 mm long and spaced 70 mm apart along the perimeter of the mesh 40.

A toothed wedge 50 (see FIG. 6) is inserted between the mesh 40 and the frame 46 in order to hold the mesh 40 into the frame 46.

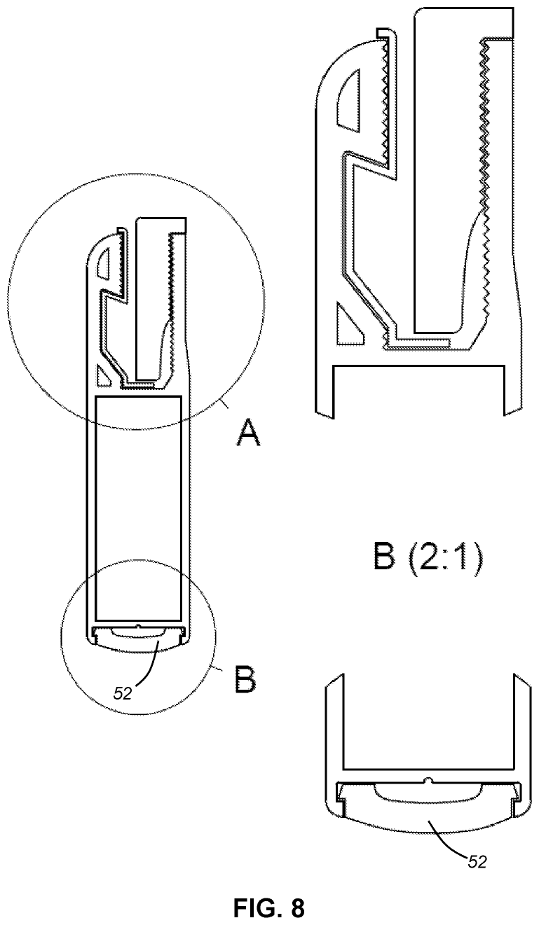

FIG. 8 shows another aspect of the present invention which is a plastic strip 52 which limits the ingress of a jimmy bar or other similar tool (such as screwdriver) between the security door and the door frame to prise the door open.

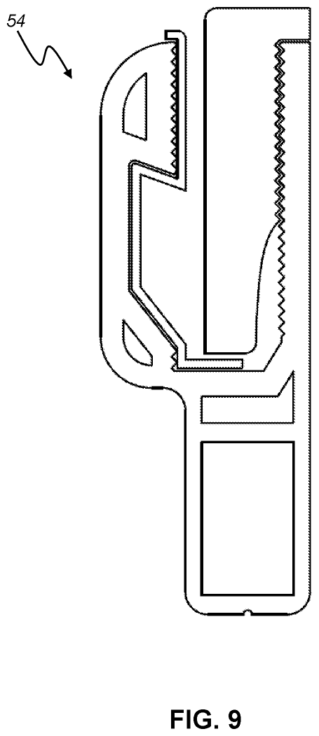

FIG. 9 shows a security screen assembly 54 adapted for a window, rather than a door.

The method of assembling the security screen of the present invention comprises:
(a) cutting and punching regularly spaced indentations along the perimeter of a mesh;
(b) forming a frame with a reinforced lip;
(c) inserting the mesh into each side of a frame so that the indentations abut the reinforced lip; and
(d) inserting wedges between the frame and the mesh to retain the mesh in the frame.

The present invention therefore has no points at which the frame and mesh come in contact which could allow corrosion. All edges of the mesh 40 are secured into frame 46, including the top edge which increases its resistance to forced intrusions. The method of manufacturing the present invention confers a substantial contribution because it provides a faster and stronger manufacturing process.

In the present specification and claims (if any), the word ‘comprising’ and its derivatives including ‘comprises’ and ‘comprise’ include each of the stated integers but does not exclude the inclusion of one or more further integers.

Reference throughout this specification to ‘one embodiment’ or ‘an embodiment’ means that a particular feature, structure, or characteristic described in connection with the embodiment is included in at least one embodiment of the present invention. Thus, the appearance of the phrases ‘in one embodiment’ or ‘in an embodiment’ in various places throughout this specification are not necessarily all referring to the same embodiment. Furthermore, the particular features, structures, or characteristics may be combined in any suitable manner in one or more combinations.

In compliance with the statute, the invention has been described in language more or less specific to structural or methodical features. It is to be understood that the invention is not limited to specific features shown or described since the means herein described comprises preferred forms of putting the invention into effect. The invention is, therefore, claimed in any of its forms or modifications within the proper scope of the appended claims (if any) appropriately interpreted by those skilled in the art.

1. A security screen assembly comprising:
(a) a frame with a reinforced lip;
(b) a mesh;
(c) a plastic insulator to insulate the frame from the mesh; and
(d) a retaining wedge to hold the mesh in the frame;
wherein the mesh has cut and punched indentations which abut against the reinforced lip and the plastic insulator to prevent the mesh being withdrawn from the frame once the retaining wedge is in place.

2. A method of assembling a security screen, the method comprising:
(a) cutting and punching indentations along the edges of a mesh;
(b) forming a frame with a reinforced lip;
(c) inserting the mesh into each side of a frame so that the indentations abut the reinforced lip; and
(d) inserting wedges between the frame and the mesh to retain the mesh in the frame.

3. The assembly of claim 1, wherein the security screen assembly is part of a door, and the door has a strip along its edge adjacent to a door jamb, to prevent the insertion of a tool between the door and the door jamb to prise the door open.
